(19) United States
(12) Patent Application Publication
(10) Pub. No.: US 2026/0252898 A1
(43) Pub. Date: Aug. 27, 2026

(54) DOCUMENTATION IMPROVEMENT

(71) Applicant: SPECIFIC-GROUP MD USA LLC, Seattle, WA (US)

(72) Inventors: Josef Bartholomäus SCHIEFER, Bellevue, WA (US); Marcus-Emanuel BRANDSTETTER, Vienna (AT); Aliaksandr KHARUZHY, Warsaw (PL)

(21) Appl. No.: 19/059,792

(22) Filed: Feb. 21, 2025

(51) Int. Cl. G06N 3/092

(52) U.S. Cl. CPC G06N 3/092

(57) ABSTRACT

A computer-implemented method is performed by an autonomous reinforcement learning artificial intelligence agent. The method is for iteratively improving documentation for a software application. The method comprises generating a new documentation version based on one or more selected strategies, the generating comprising extracting information from a data source and providing a prompt and the extracted information as input to a large language model LLM which generates output based on the input, the new documentation version being generated based on the LLM output. An LLM-as-a-judge is invoked for comparing the new version with a previous documentation version and determining whether the new version is an improvement over the previous version. The autonomous agent receives a reward when the new version is an improvement over the previous version, the reward reinforcing the one or more strategies used to generate the new documentation version.

### TECHNICAL FIELD

The present invention relates to documentation for software applications.

### BACKGROUND

A software application is often accompanied by documentation including written text which explains how the software operates and how to use it. Documentation for an application is typically produced manually and constraints on developer time and resources mean that documentation can be brief and out of date.

The embodiments described below are provided by way of example only and are not limiting of implementations which solve any or all of the disadvantages of known methods for improving documentation.

### SUMMARY

This summary is provided to present a selection of concepts disclosed herein in a simplified form, which are described in more detail below. This summary is not intended to identify key features or essential features of the claimed subject matter nor is it intended to be used to limit the scope of the claimed subject matter.

A computer-implemented method is performed by an autonomous reinforcement learning artificial intelligence agent. The method is for iteratively improving documentation for a software application. The method comprises generating a new documentation version based on one or more selected strategies, the generating comprising extracting information from a data source and providing a prompt and the extracted information as input to a large language model LLM which generates output based on the input, the new documentation version being generated based on the LLM output. An LLM-as-a-judge is invoked for comparing the new version with a previous documentation version and determining whether the new version is an improvement over the previous version. The autonomous agent receives a reward when the new version is an improvement over the previous version, the reward reinforcing the one or more strategies used to generate the new documentation version.

### DESCRIPTION OF THE DRAWINGS

The present description will be better understood from the following detailed description read in light of the accompanying drawings, wherein:

FIG. 1 is a schematic diagram showing documentation improvement;

FIG. 2 is a schematic diagram showing an example knowledge graph;

FIG. 3 is a schematic diagram showing iterative documentation improvement;

FIG. 4 is a schematic diagram which shows generating a few-shot prompt;

FIG. 5 is schematic diagram showing an example version history database;

FIG. 6 is a flow diagram showing an example computer-implemented method for improving documentation; and

FIG. 7 illustrates an exemplary computing-based device.

### DETAILED DESCRIPTION

The following description is presented in connection with the appended drawings and is intended as a description of the present examples to enable a person skilled in the art to make and use the invention. The description is not intended to represent the only forms in which the present examples are constructed or utilized. The present invention is not limited to the embodiments described herein and various modifications to the disclosed embodiments will be apparent to those skilled in the art.

Software applications are programs or groups of programs which perform specific tasks. Accompanying documentation may comprise written materials that describe architecture, functionality, and/or usage instructions. Complex architecture and code dependencies make applications challenging to understand and use without suitable documentation. Documentation may be produced and/or used in many scenarios. In a particular scenario provided purely by way of example, documentation may be provided for adding new printers, such as adding a line printer or a network printer. Sometimes, documentation for adding new printers is incomplete, scattered across archived text files or outdated internal wikis. This often forces administrators to rely on knowledge which may be second-hand knowledge when configuring or updating printing services.

Documentation is typically generated manually by developers. Sometimes, documentation is generated automatically for example using a generative model such as a large language model. Once documentation has been produced or generated, it often has some deficiencies. For example, an initial documentation version could be found to be lacking in terms of technical accuracy, technical detail, readability, clarity, style, or comprehensiveness. To manually improve documentation is time consuming and developers under time and resource constraints often do not improve on poor documentation. This results in documentation which may be incorrect or difficult to follow. Low quality documentation for example makes software applications difficult to use, leads to user errors and wasted resources.

Disclosed herein are various methods and systems for improving documentation for a software application.

Some methods disclosed herein are performed by a computer-implemented autonomous reinforcement learning artificial intelligence agent. An autonomous reinforcement learning artificial intelligence agent is variously referred to herein as an autonomous agent, a reinforcement learning (RL) agent, or agent. An autonomous reinforcement learning artificial intelligence agent in various examples is a software-based system that operates independently with minimal human intervention. It uses reinforcement learning techniques to perform tasks which include but are not limited to: making decisions, exploring alternative solutions, and/or optimizing strategies over multiple iterations. In some scenarios, the agent continuously refines software documentation by formulating prompts for large language models (LLMs), evaluating the generated outputs, and comparing new versions of the documentation against one or more previous versions. The agent's goal may be to maximize a numerical “reward” signal that reflects improvement in documentation quality (e.g., clarity, completeness, accuracy). A reward-driven feedback loop enables the agent to learn and adapt its strategies (such as prompt composition, data source selection, or model switching) to produce progressively better documentation.

The agent uses one or more large language models (LLMs) and prompts provided to the LLMs to produce new documentation versions. Examples of suitable large language models are GPT-4, Llama, Claude or any other suitable model. Such LLMs are generative models, which produce output based on the prompt provided to them. Output is generated by an LLM in response to a prompt.

The agent disclosed herein can also provide information to an LLM which is used to make a new documentation version. The information may be extracted from a data source and used by the LLM to generate output. In various examples the information is extracted from a data source which is a knowledge base comprising information about the software application, which is sometimes a graph-based knowledge base. In other examples, the data source is a repository or code archive containing code snippets relating to the application. In further examples the data source is an external data source such as the internet. In various examples, the data source includes code snippets, historical developer notes, and/or relevant system commands.

As described above, in various examples a new documentation version is generated by providing input to an LLM. The input comprises a prompt and extracted information from a data source. In response to the prompt, the LLM produces output. The output is used by the agent to produce a new documentation version. The new documentation version is produced based on one or more strategies selected by the agent. Strategies are approaches or techniques used by the agent to produce new documentation versions. Different strategies or combinations of strategies lead to different documentation versions. Examples of strategies include but are not limited to: generating prompt variants which are different versions of an initial prompt, decomposing an initial prompt into a plurality of sub-prompts, querying a plurality of LLMs, using information from different data sources, using few-shot prompting.

Generating prompt variants, which may also be called prompt variation, refers to generating different versions, variants, or variations of a prompt. Variations in style, depth or focus may be introduced. Sometimes, prompt variants are generated using an LLM. Decomposing a prompt into sub-prompts refers to making a plurality of prompts from an initial prompt where each sub-prompts relates to a different aspect of the initial prompt or the documentation. For example, a prompt could be broken down into different documentation sections such as security, integration points, or database schemas.

A plurality of LLMs may be employed by the agent to make a new documentation version. For example, the same prompt could be provided to different LLMs which produce different results. When the agent provides the same or similar prompts to multiple LLMs, each LLM may produce varying responses for example due to different underlying architectures, training corpora, or parameter settings. The agent can then compare responses and may select a single best response that aligns most closely with desired criteria (e.g. detail, accuracy and/or clarity). Additionally or alternatively, the agent may synthesize a final output by combining output from multiple LLMs. For example, particularly strong sections or passages from multiple LLM outputs may be combined to form a new documentation version.

In an example, one LLM may excel at providing highly detailed technical explanations, while another may produce more succinct or stylistically appealing text. The agent evaluates these outputs and merges the best parts into a cohesive documentation version. Sometimes, outputs are evaluated using an LLM-as-a-judge. Over repeated iterations, the agent learns which LLMs or which specific model prompts best suit particular aspects of the documentation (e.g., technical depth versus user-friendliness). Thus, the agent strategically leverages the unique strengths of each LLM to optimize the resulting documentation. In further examples, some sub-prompts are input to different LLMs.

Including information from different data sources also results in different documentation versions. In various examples information from a knowledge base related to the software application is extracted by the agent which may be a graph-based knowledge base.

Few-shot prompts are prompts which contain one or more shots or exemplars. Exemplars are examples which are used by the LLM to produce output. In some examples, the agent experiments with few-shot prompting. The agent may compare documentation generated using few-shot prompts to zero-shot prompts. The agent may also compare documentation generated using different types of exemplars or numbers of exemplars in some scenarios.

In examples, the agent explores a strategy space in order to improve documentation generation. Testing different strategies means that the agent can find those strategies which result in improved documentation. This leads to the advantages of improved documentation as described above. It also makes the documentation improvement more efficient because, once effective strategies are identified, resources are not wasted using other less effective strategies.

Some examples described herein involve generating a new documentation version which includes one or more commands and/or one or more instructions for performing a computing task. The commands and/or instructions map out steps for performing a computing task on a computing system. For example, the task could be integrating a new printer or other peripheral computing device to an existing computing system, and improved documentation could include parts such as: commands, object libraries, settings, notes on authorization, notes on subsystem routing. Improved documentation in some cases can be used to automate the computing task. Because the steps are mapped out (sometimes including the actual commands, libraries, settings and authorizations required), the documentation provides enough detail for the task to be automated.

Sometimes, the new documentation version is included in a pipeline configured to perform a computing task and the pipeline is executed such that the computing task is performed. This allows the computing task to be performed more efficiently, since information on how to perform the task is automatically included in the pipeline via the new documentation version. It also leads to a reduction in errors and configuration times, and ensures consistent practices across multiple environments.

Once the new documentation version has been generated, it is determined whether the new version is an improvement over a previous version. The agent determines this by invoking an LLM-as-a-judge. An LLM-as-a-judge evaluates the new documentation version compared to the previous version for qualities such as: readability, technical accuracy, comprehensiveness, style, or other suitable qualities. If the new version is found to be improved, the agent receives a reward. The reward reinforces the one or more strategies used to generate the new documentation version. This means that the agent is more likely to use those successful strategies in further iterations, further improving the documentation.

Employing an autonomous, reinforcement learning-driven approach leads to continuous improvement in documentation. The reinforcement learning (RL) agent may learn to produce more accurate, comprehensive and contextually relevant documentation. Documentation generation may be treated as a continuous learning cycle. The RL agent experiments with various strategies (for example altering prompts, exploring different data sources, and using a range of LLMs) to identify which methods best enhance documentation quality. By continuously adapting and refining its strategies, the agent continues to improve documentation.

Various methods described herein also provide scalable autonomy by enabling the autonomous agent to explore a strategy space with minimal human intervention. The strategy space includes prompt variation, sub-prompts, multiple models, and data augmentation. The agent may also use adaptive knowledge integration by dynamically incorporating new information sources (for example knowledge graph nodes, code repositories, databases, internet resources). Some methods described also result in improved prompt engineering. By continuously evolving prompt design, parameters and structure, better LLM responses and more coherent documentation is produced. Some methods and systems use multiple LLM backends. This means that it is possible to identify which combination yields the highest-quality output for given documentation tasks.

In various examples, an autonomous reinforcement learning (RL) agent orchestrates documentation improvement. The agent issues prompts to LLMs, utilizes data sources (for example a knowledge base and knowledge graph) and tries various ways to enhance output quality. Each iteration yields new documentation versions that are scored against previous ones, using an LLM-as-a-judge component. If a new version scores higher than a previous one, the agent receives a reward and adjusts its strategies accordingly. A higher score may result from the new documentation version being more detailed, better organized, or more technically accurate.

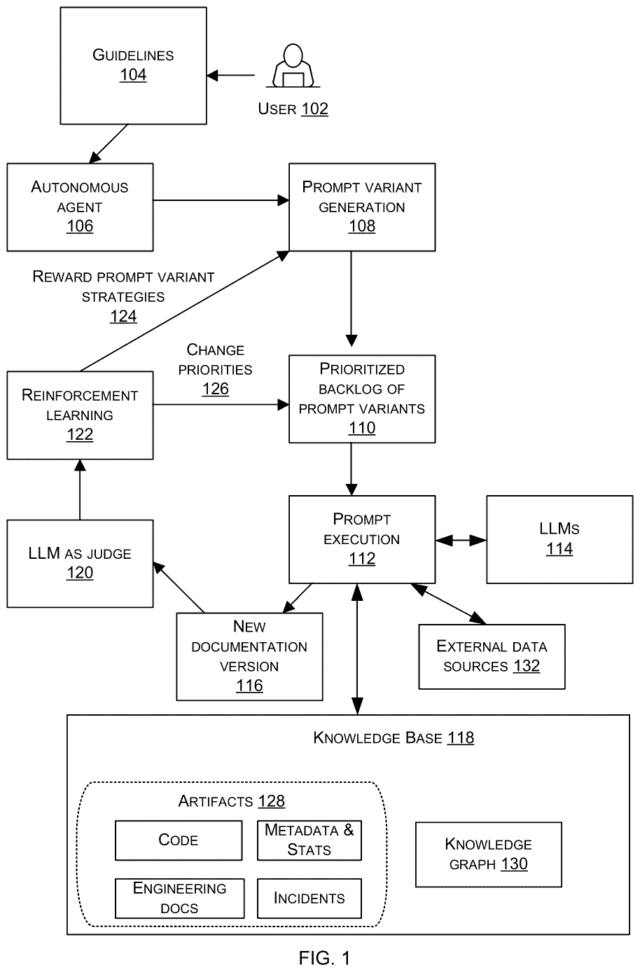

FIG. 1 is a schematic diagram showing documentation improvement. The documentation improvement is orchestrated by an autonomous reinforcement learning (RL) agent 106. In various examples the agent operates as a closed-loop system, meaning that the agent continuously monitors, evaluates, and adjusts its own actions based on feedback. Various actions of the agent may include: prompt generation, execution and output, evaluation, reward and policy update, iterative refinement. During prompt generation, the agent formulates prompts (or prompt variants) to generate new documentation. During execution and output, one or more LLMs process these prompts and produce candidate documentation versions. During evaluation, an LLM-as-a-judge compares each new documentation version against the current best version, scoring it for improvements in detail, clarity, and other quality metrics. During reward and policy update, the agent receives an award if the new documentation version is deemed better. This reward modifies the agent's policy, which is the agent's internal decision-making function and leads it to favor strategies that have consistently produced superior documentation. During iterative refinement, the agent re-enters the loop, generating revised or alternative prompts, or changing the order of a backlog of prompt variants, informed by the updated policy. Because the output of each iteration directly influences the next iteration's inputs and strategies, the system remains closed in the sense that it continually feeds back into itself without requiring external intervention for every decision step.

Depicted in FIG. 1 is a user 102 who provides autonomous agent 106 with guidelines 104 for example policies, mission, boundaries, and/or success criteria 104. Guidelines 104 provide the autonomous agent 106 with a scope for example of allowed data sources, acceptable resource usage levels (e.g. computational budgets, API call limits) and/or any organizational or regulatory constraints. Guidelines 104 help to ensure the agent's exploration remains focused, cost effective, and compliant with organizational standards.

Based on the user-provided guidelines, autonomous agent 106 orchestrates documentation improvement. The autonomous agent uses one or more large language models (LLMs) 114 to generate new documentation versions. In various examples a new documentation version comprises output from one or LLMs. Autonomous agent 106 may generate multiple prompt variants (also called variations) as depicted at 108 in FIG. 1. Prompts represent input to the LLMs and contain information and instructions for the LLM to use when generating a new documentation version. Different prompts often results in different output from the LLM. Generating prompt variants at 108 means that multiple different prompts may be used to make different documentation versions and the most suitable document version may be selected. Generating prompt variants allows autonomous agent 106 to explore the effects of different prompts. Prompt variants are generated 108 based on one or more strategies. Examples of strategies include generating prompt variants which are different versions of an initial prompt, decomposing an initial prompt into a plurality of sub-prompts, querying a plurality of LLMs, using information from different data sources, using few-shot prompting. In various example scenarios prompt variants are generated in one or more of the following ways: by breaking down prompts into sub-prompts targeting specific documentation sections (e.g. security, integration points, database schemas); introducing variations in style, depth or focus; using different LLM backends; using meta-prompting.

Prompt execution is depicted at 112 wherein the prompt execution uses one or more LLMs 114. In the example shown in FIG. 1, prompt execution 112 is the execution of a prompt selected from the prompt variants generated at 108. In various examples LLMs 114 shown in FIG. 1 comprise one or more LLMs such as GPT-4, Claude, Llama, or any other suitable model. In various scenarios autonomous agent 106 interacts with multiple LLMs to produce candidate documentation versions. The agent may switch between models, for example producing multiple documentation versions by providing the same prompt to multiple models.

Additionally or alternatively outputs from different models may be combined together so as to leverage the strengths of each LLM. For example, the agent can send the same prompt to multiple LLMs in parallel or in sequence to generate a range of candidate outputs. Each LLM may have particular strengths. For instance, one might excel at generating very detailed technical explanations, while another might produce succinct or stylistically refined text.

In various scenarios the agent decides how to use each LLM in one or more of the following ways. The agent may decide how to use each LLM based on historical performance. Over time, the agent tracks how well each LLM's output scored in terms of accuracy, clarity, or comprehensiveness. LLMs that consistently perform better at certain tasks may be chosen for those aspects of the documentation. The agent may decide how to use each LLM based on use-case matching. The agent can match each LLM to documentation needs. For example, a specialized LLM might have domain expertise for compliance-related sections, whereas a more general LLM might be best at producing user-friendly summaries. The agent may decide how to use each LLM by combining outputs. After receiving output from multiple LLMs, the agent can fuse their best parts into a single new version. For example, it might take detailed code samples from one LLM but merge them with a clearer explanation from another. The agent in some examples evaluates the combined result using the LLM-as-a-judge to ensure coherence and consistency. In these and various other scenarios, the agent orchestrates different LLMs to capitalize on each model's strengths, iteratively refining the documentation towards higher quality.

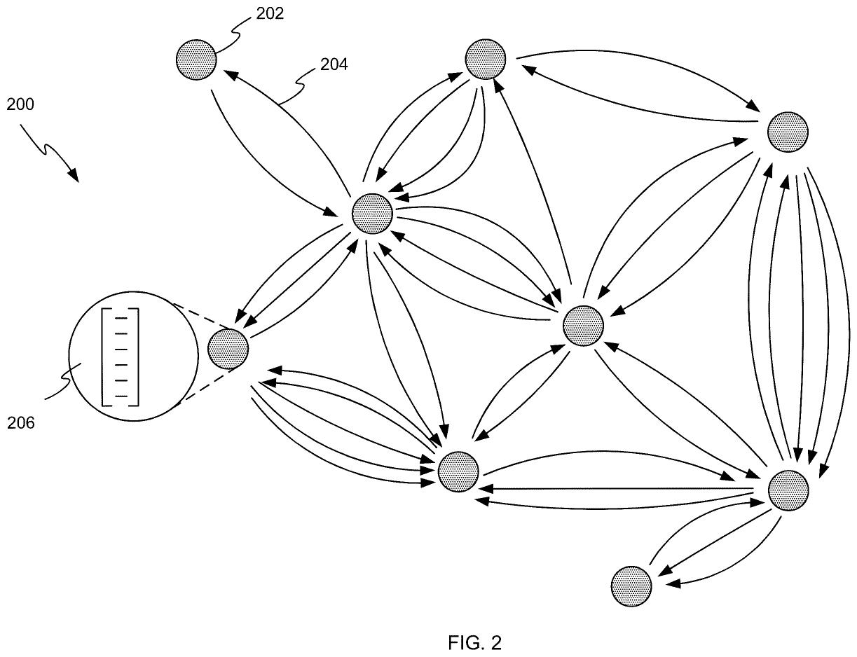

Prompt variants are executed as shown at 112. In various examples information from a knowledge base 118 is also provided as input to the LLM. Knowledge base 118 is a graph-based knowledge base which leverages a knowledge graph 130. As described in more detail below with respect to FIG. 2, the knowledge graph 130 efficiently represents and manages code dependencies and relationships between different software artifacts 128. The term artifact refers to a concept which defines the structure or knowledge of program, source code or database. An artifact represents valuable information about an item or element within the software. In various examples an artifact is an item produced during the software development process. Examples of software artifacts include but are not limited to: Java classes, methods, routines, variables, code repository artifacts (e.g. code files, version histories, commit messages), documents, content, documentation, test cases, domain objects, and relationships between any of the former.

In various scenarios, the knowledge base includes a knowledge graph with interconnected nodes representing code modules, database schemas, or configuration files providing structured context. The agent may “walk” these graphs to find missing details, refine explanations, or link related concepts. Additionally or alternatively autonomous agent 106 also uses artifacts 128 in the knowledge base 118 including: code or code snippets, commit histories, configuration files, metadata and statistics, engineering documentation and incidents.

Some prompt variants may comprise instructions to use external data sources 132 to produce a new documentation version. External data sources are data sources external to the knowledge base 108 which is a knowledge base for the software application. External data sources include corporate wikis, partner APIs, the open internet. In various examples, during prompt execution 112 the autonomous agent retrieves information from external data sources 132 and provides the retrieved information as input to LLMs 114. Sometimes, the autonomous agent checks the retrieved information for alignment with security and/or compliance policies.

A new documentation version 116 is produced as a result of prompt execution 112. In various examples the new documentation version is output from one or more LLMs. LLM output can be used directly as the new documentation version. In other examples the new documentation version is a result of processing output of one or more LLMs by the autonomous agent 106. For example, the new documentation version is a combination of output from multiple LLMs produced by the agent merging or transforming outputs from multiple LLMs to form a cohesive new documentation draft. Sometimes, the agent concatenates relevant parts of each LLM's response. The agent can also handle transitions so the text remains coherent. Additionally or alternatively, the agent can replace or rewrite certain sections if one LLM provided a superior explanation or code snippet than another. The means that documentation is improved because the documentation benefits from the best elements from available LLM outputs.

Where the agent produces a new documentation version from output from one or more LLMs, the agent may apply post-processing steps before finalizing the documentation version. Post-processing operations include removing duplicate information or enforcing organizational style rules. Post-processing means that the quality of the new documentation version is improved.

An LLM-as-a-judge 120 is employed by autonomous agent 106. The LLM-as-a-judge 120 is a mechanism to compare a new documentation version against a best previous version using an LLM. The LLM employed as a judge is for example GPT-4, Claude, Llama, or any other suitable model. The LLM-as-a-judge is used to compare the new documentation version with a previous documentation version. The new documentation version and previous documentation version are provided as input to the LLM along with a prompt comprising instructions for determining whether the new version is an improvement over the previous version. An improvement may be an improvement in technical detail, technical accuracy, organization, level of detail, clarity, or compliance. Additionally or alternatively the improvement could be a stylistic improvement, or an improvement because the new documentation is more comprehensive.

In various scenarios, the agent provides a new documentation draft and a previous version of the documentation to the LLM-as-a-judge along with evaluation criteria. For example, the evaluation criteria provided by the agent is one or more of: accuracy, clarity, comprehensiveness, style, compliance.

In response, the LLM-as-a-judge 120 may output one or more numeric quality scores. A score could be a number between zero and ten which quantifies an amount of improvement of the new version over the previous version. Sometimes, the LLM-as-a-judge outputs a score for different criteria such as a score for one or more of accuracy, clarity, comprehensiveness, style or compliance. In some scenarios, the LLM-as-a-judge outputs one or more numeric scores, each score being accompanied by text which explains or justifies the numeric score.

Additionally or alternatively, the LLM-as-a-judge outputs text describing improvement of the new version over the previous version. The text may be a textual structured evaluation. An example of a structured evaluation is “New version is better in clarity and completeness but weaker in style”. In some examples, the LLM-as-a-judge can be prompted to explicitly compare each dimension of quality and generate textual justifications for the conclusions reached. An example textual justification is “The new version includes more thorough code samples and is thus superior in accuracy”. The LLM may then conclude with a numeric overall improvement score. Using such a systematic approach means that the agent can precisely determine whether the new version is better and by how much.

In an example, in order to determine whether the new documentation version is an improvement, the agent determines whether a score exceeds a threshold score. If the score is a number between zero and ten, then the threshold may be five. If the score exceeds the threshold, then the agent determines that the new version is an improved version. If the score does not exceed the threshold, then the agent determines that the new version is not an improvement. Sometimes, the agent determines whether the new version is an improvement based on an aggregated score and comparing an aggregated score to a threshold. If the aggregated score exceeds the threshold, then the agent determines that the new version is an improved version. If the aggregated score does not exceed the threshold, then the agent determines that the new version is not an improvement. In some scenarios, an aggregated score is a weighted sum of sub-scores. Sub-scores may be output by the LLM-as-a-judge for example for different criteria such as clarity, comprehensiveness, style or compliance.

The determination of whether the new documentation version is improved is used in reinforcement learning 122. When the new documentation is improved, autonomous agent 106 receives a reward, as depicted by arrow 124 in FIG. 1. The reward is for the strategies used to produce the prompt variant which generated the new documentation version using one or more LLMs 114. If a reward is received, the reward influences a policy of autonomous agent 106. In an example, the reward changes the policy and guides the agent to favor strategies (for example certain prompt decomposition patterns, specific data sources or preferred LLMs) and variations that have historically led to better outcomes. If no improvement is detected or if the new documentation version is deemed worse then the agent either receives no reward or a negative reward.

Sometimes, as shown in FIG. 1 the autonomous agent 106 manages a prioritized backlog of prompt variants 110. This is a queue of prompt variants which the agent will try in order of priority. Prompt variants produced with strategies that previously yielded successful outcomes are given higher priority, while less effective strategies are deprioritized or discarded over time. As a result of output from LLM-as-a-judge 120, the priorities in backlog 110 may change as depicted by arrow 126. In various scenarios, iterative queue management means that the agent's exploration remains dynamic, continuously moving towards the most fruitful approaches and not wasting resources on unproductive experiments. Another new documentation version may then be created from the next prompt variant in the backlog 110.

A documentation improvement process such as the process schematically depicted in FIG. 1 is iterative in various scenarios. Multiple new documentation versions are continuously generated and assessed by LLM-as-a-judge 122. Over multiple iterations, the system gravitates toward strategies that deliver measurable improvement. For example, agent 106 refines its prompts, integrates richer data sources, experiments with different LLMs, and adapts its approach according to feedback. This creates a positive feedback loop wherein successful strategies are reinforced, and less effective strategies are gradually phased out. As the system converges on optimal strategies, it produces continually improving documentation that remains aligned with evolving organizational data, user needs, and compliance requirements.

Reinforcement learning 122 and strategy selection for improved documentation are described in more detail hereafter. In various examples, reinforcement learning enables the agent to discover and refine strategies which consistently improve documentation quality. In an example, an agent may begin with no preference as to how to generate documentation so as to improve documentation quality. Initially, the agent selects strategies by trial and error. The agent tries various strategies and an LLM-as-as judge such as 120 provides feedback for example on clarity, comprehensiveness and accuracy. Over time, feedback and reward signals help the agent to converge on strategies which produce the best outcomes.

In an example of a trial and error process, the agent experiments with diverse strategies. Various examples of strategies include adjusting a prompt to make a prompt variant, querying multiple LLMs, or integrating new data sources. Using one or more strategies, a prompt variant is generated and a new documentation version is produced based on the prompt variant.

After generation, an LLM-as-a-judge such as 120 is invoked which compares the new documentation version with a previous version. In some examples the previous version is the previous best version. If the new documentation version is improved as determined by the LLM-as-a-judge, the RL agent receives an award. The awards reinforces the strategy or strategies which led to the improvement. The agent uses the reward signals to update its internal policy. Strategies which yield improvements gain prominence, while unhelpful approaches are used less frequently over time.

In the example above, the agent's decision making is informed by each iteration. This helps the agent to converge on a combination of strategies which improve documentation for example by producing higher quality, more accurate and policy-compliant documentation. Therefore over time the agent recognizes which strategies (e.g. types of data sources, LLMs, and prompt variations) lead to reliable improvements in documentation quality.

As described with reference to FIG. 1, a prompt variant is executed 112 to produce a new documentation version 116 using information from a knowledge base 118 which is a graph-based knowledge base leveraging a knowledge graph 130. The knowledge base and knowledge graph serve as dynamic libraries of information. Instead of relying solely on static text, the autonomous agent can traverse interconnected nodes representing code modules, database schemas and configuration files. For example, if a particular documentation section falls short, the agent may “walk” through the graph to find missing details, enrich descriptions, or discover related topics that should be mentioned.

FIG. 2 is a schematic diagram showing an example knowledge graph 200. Knowledge graph 200 is an example of knowledge graph 130 in FIG. 1. The agent may extract information from the knowledge graph which is used to make a new documentation version. Knowledge graph 200 includes nodes such as node 202 and edges such as 204. Edges link the plurality of nodes in the knowledge graph. Knowledge graph 200 is generated for example using data sources from the software application such as code repository artifacts, documentation and data and metadata from databases. In various examples, each node 202 stores data related to an artifact of the software application and each edge 204 represents a relationship between artifacts of the software application. For example a node represents an entity which could be a module, a database table, an error message, a function or any other suitable artifact. An example relationship between two nodes may be that a function is part of a module. Information about an entity represented by a node is annotated to the node in some cases, or a reference annotated to the node refers to a storage location where the information is stored.

Some example knowledge graphs are generated by a process which involves converting software code, configuration, or other structured files into a representation comprising a “textual” graph along with a set of facts associated with the graph's nodes and edges. A fact, also called a triple, is represented as text. A triple includes a subject, a predicate, and an object. The predicate describes the relationship between two nodes, the subject and the object. If a node is used in more than one triple then the node may be both a subject and an object simultaneously. In various scenarios, the process for generating example knowledge graphs uses traditional parsing techniques and/or machine learning models such as large language models which may be combined with categorization, normalization and duplicate checks.

In some scenarios, each node 202 stores a vector embedding of the artifact stored at, or referenced by the node. An example vector embedding is depicted at 206 in FIG. 2. For example, a node stores data related to a code snippet, and the node further stores a vector embedding of the code snippet. In various examples, embeddings are computed for facts, combined facts, and graph node structures (expressed as text) along with their combined facts. A vector embedding may be generated for example using an encoder model. The encoder model may be a neural network or any other suitable type of model. A non-exhaustive list of examples of encoder models which may be used is CLIP, BERT. Where two or more different encoder models are used, a mapping component maps the outputs of the different encoder models to a common embedding space.

Information from knowledge graph 200 may be retrieved by following edges such as 204 in the graph starting from a starting node. Each edge represents a relationship between the two nodes that the edge connects. Therefore, by retrieved artifacts in the nodes connected to the starting node, relevant information is retrieved. In some examples, information is retrieved from the knowledge graph using a vector search in vector space as well as by travelling along edges of the graph to find neighboring nodes of a starting node.

Additionally to information contained in a knowledge graph such as 130 or 200, the agent may leverage information from external sources. The RL agent may fetch sources from one or more of: the internet, corporate wikis, specialized databases. If an external lookup leads to a significant improvement, that approach is reinforced encouraging the system to consider outside information more frequently in future iterations.

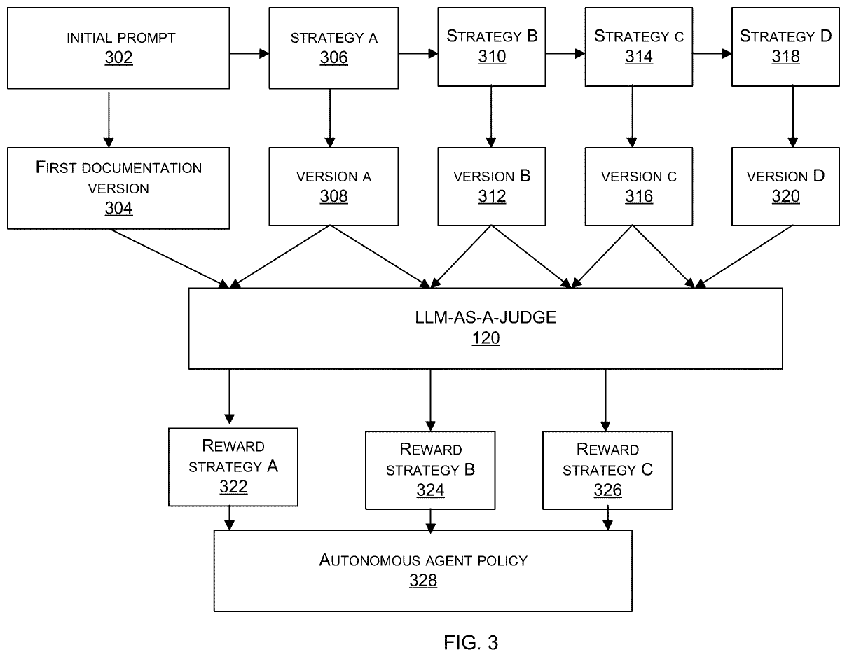

FIG. 3 is a schematic diagram showing example aspects of reinforcement learning for improved documentation. In the example shown in FIG. 3, the agent starts with an initial prompt 302. In some examples the initial prompt is a more simple prompt which is used to query a single LLM. An example initial prompt is “generate comprehensive technical documentation for a new microservice called service A”. The initial prompt results in a first documentation version 304. The first documentation version 304 may be a relatively basic documentation version for example including a high-level overview of the service, a summary of its features and some usage examples. LLM-as-a-judge 120 evaluates the first documentation version 304 and compares it to a trivial baseline (i.e. no documentation) and the first documentation version is as the current best version. Since there is no previous benchmark to improve upon, the agent neither receives a reward nor a penalty at this stage. In other examples, the first documentation version 304 is not the result of an initial prompt but could be human-generated or generated using any other suitable method.

The autonomous agent subsequently uses strategy A to generate a new documentation version A 308. For example, strategy A might comprise querying an additional LLM or decomposing the prompt into sub-prompts. LLM-as-a-judge 120 compares version A 308 with the first documentation version 304. In the example from FIG. 3, the LLM-as-a-judge finds version A 308 to be an improvement over the first version 304 and rewards strategy A as shown at 322. The reward results in a change to the autonomous agent policy 328.

In a similar way the agent subsequently uses strategy B 310 to generate a new documentation version B 312. In an example strategy B might comprise integrating code snippets from an internal repository and involves extracting information from knowledge base 118. LLM-as-a-judge 120 finds that the documentation is improved by the use of strategy B. For example, the LLM-as-a-judge may find that the documentation is more actionable and usable because it includes code snippets. A reward is granted for strategy B as shown at 324.

The agent subsequently uses strategy C 314 to generate version C 316. In an example strategy C could comprise exploring compliance and/or external references. LLM-as-a-judge 120 finds that the documentation is improved by the use of strategy C. For example, the LLM-as-a-judge may find that highlighting compliance considerations and referencing authoritative internal standards adds value. A reward is granted for strategy C as shown at 326.

Strategy D 318 is then used to generate a version D 320 of the documentation. In an example strategy D could comprise integrating details from an internet post on an unverified forum. In a scenario, the information in the internet post is not trustworthy because it is outdated and inaccurate. LLM-as-a-judge 120 determines that version D is not improved over version C for example because it is inaccurate and misleading. As a result, strategy D is not rewarded which is a signal to the autonomous agent that strategy D did not result in improved documentation. The autonomous agent policy 328 updates to reflect that strategy D was not beneficial which means that the agent will deprioritize or avoid strategy D.

In the example of FIG. 3, each iteration informs decision making of the autonomous agent and helps the agent to converge on strategies which result in improved documentation.

One type of strategy which may be employed to generate a prompt variant used to produce a new documentation version is few-shot prompting. Few-shot prompting involves providing the LLM with one or more examples, called exemplars or shots. The exemplars guide the style, depth and structure of the documentation output. In examples where few-shot prompting is used, the agent may construct few-shot prompts from anonymized, high-quality technical documentation produced for a different software application. In that case the agent may check that no sensitive or proprietary details are revealed.

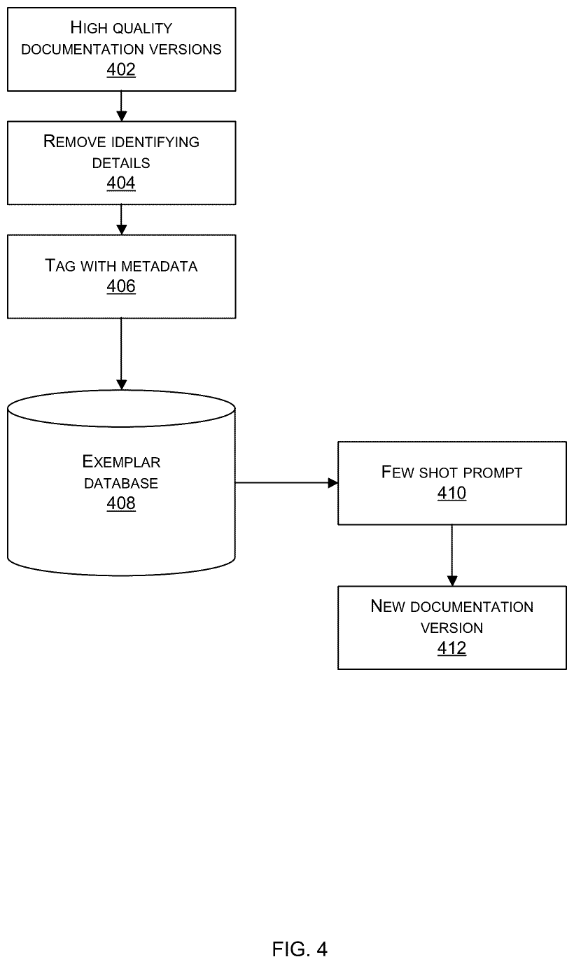

FIG. 4 is a schematic diagram which shows generating a new documentation version with few-shot prompting. An exemplar database 108 is a data store of exemplars for including in a few-shot prompt. In various examples, the exemplars in the exemplar database 408 are documentation versions which may be associated with the current software application or a different software application. In scenarios, the exemplars are identified by the agent as documentation versions which have consistently outperformed previous drafts. In FIG. 4, high quality documentation versions 402 are identified for example by the agent. Identifying details are removed 404 and the documentation version are tagged with metadata. Example metadata includes strengths of the documentation version. For example, one documentation version may have improved code snippet integration, another may have improved compliance documentation, and another may have improved structuring API endpoint details. Tagging via metadata allows the agent to quickly select examples which emphasize the qualities it seeks to improve in the current documentation task.

In FIG. 4, exemplars are selected from exemplar database 408 for inclusion in a few-shot prompt 410. Including exemplars in a few-shot prompt means that an LLM is guided towards producing similar high-quality output. In FIG. 4, a few-shot prompt 410 is used to generate new documentation version 412. The autonomous agent may select one or more exemplars based on a desired format, a desired level of technical detail, a desired comprehensiveness and/or a desired clarity. In various examples, the agent determines which exemplars to use in one or more of the following ways. The agent may use metadata tags of the exemplars. Metadata tags are tags attached to exemplars in the database. Example descriptors include “high technical depth”, “emphasizes compliance”, “excellent code coverage”, or “written in a user-friendly style”. Exemplars may then be chosen with metadata tags corresponding to desired qualities of the new documentation version. The agent may use current documentation gaps to determine which exemplars to use. For example, if the LLM-as-a-judge consistently identifies a lack of clarity or insufficient technical detail in recent drafts, the agent prioritizes exemplars tagged with “clear structure” or “deep technical explanations”. The agent may use user or organizational requirements to determine which exemplars to use. For example, the agent may parse guidelines or policies specifying the needed compliance level, the required style, or an emphasis on real-world examples. The agent may use performance history to determine which exemplars to use. Over multiple iterations, the agent can track which exemplars led to improved documentation outcomes, thereby learning which ones best solve particular deficiencies (such as security details or integration instructions). Selecting exemplars using one or more of the ways described above means that the agent selects exemplars aligned with the agent's objectives such as increased clarity, deeper coverage of code-level details, or more advanced compliance sections. The agent can systemically incorporate selected exemplars into a few-shot prompt to guide the LLM towards producing improved output for documentation.

In various scenarios the agent experiments with combinations of exemplars to include in a few-shot prompt such as 410. By assessing the documentation versions produced with few-shot prompts (using an LLM-as-a-judge), the agent may determine that some combinations of exemplars yield better outcomes. Successful configurations of few-shot examples may be rewarded and become a reliable strategy in subsequent attempts. In other words, the agent assesses whether adding few-shot examples led to improved documentation. If the LLM-as-a-judge rates the resulting draft higher than a version without few-shot prompting, the strategy is rewarded. Over time, the agent may refine the selection and number of exemplars in order to determine a stable few-shot prompting technique. In a scenario, such a few-shot prompting technical may be used to generate a first documentation version such as 304 in FIG. 3 which is produced from an initial prompt. This means that baseline quality is elevated before any further iterative refinement (such as with strategies A-D in FIG. 3). In other examples, few-shot prompting is additionally or alternatively employed to produce further new documentation versions.

Sometimes, a new documentation version includes one or more commands and/or one or more instructions for performing a computing task. The commands and/or instructions can provide details which enable an automated or scripted computing task to be performed. Commands in some examples are control language commands. In other examples, commands may be pieces of code for example in a language of the software application. Commands in the documentation may be native code snippets in the same language as the language used by the application. Example languages include Java, Python, C#, or RPG which runs on IBM i/AS/400™. Commands may also be scripts for example bash or power shell scripts that set environment variables or perform required setup steps. Commands may be SQL statements or stored procedures for database changes. In various scenarios, commands may be one of, or any suitable combination of, the example commands provided herein. In various examples, instructions specify parameters such as files, routing parameters, authorization details system requirements, security flags, compliance flags, performance tuning parameters, logging configuration parameters, and/or monitoring configuration parameters. Examples of system requirements include RAM (rapid access memory), disk space, and operating system constraints. Examples of security or compliance flags include toggles indicating data protection compliance. Performance tuning parameter examples include thread pool size, caching strategy, and timeouts. Logging or monitoring configuration parameters include log levels, log rotation, and metrics endpoints. Including commands and/or instructions in the documentation means that the new documentation version can be used to perform the computing task. Steps derived from the new documentation version may be used to perform the task.

In various examples, the new documentation version is included in a pipeline configured to perform a computing task. The pipeline benefits from accurate, up-to-date information that outlines commands, parameters and/or dependencies. The new documentation version may be incorporated into a pipeline configured to install or update a driver component for a newly added piece of equipment. As used herein, the term “pipeline” refers to an automated sequence of operations which manages for example a software change. The pipeline could be an automated upgrade pipeline or a deployment pipeline. An automated upgrade pipeline manages system or application upgrades such as rolling out new printer drivers, updating operating system level components, or upgrading to new versions of libraries or frameworks. A deployment pipeline automates the process of building, testing, and deploying new application releases. This may include pulling code from a repository, running test suites, containerizing the application, and deploying to staging or production environments. Other suitable types of pipeline include integration pipelines, data processing pipelines, or compliance pipelines. An integration pipeline focuses on connecting multiple services. A data processing pipeline may be used for extract, transform, load (ETL) processes or for machine learning processes. A compliance pipeline may be used for verifying that each deployment meets regulatory needs. The pipeline may then be executed such that the computing task is performed. For example, an automated upgrade or deployment pipeline is executed such that a software application is modified to interoperate with a piece of equipment based on steps derived from the new, improved documentation version.

A particular scenario is described wherein new documentation is generated using techniques described above and the documentation relates to integrating a new printer into a system such as an AS/400 system. Sometimes documentation for adding printers (e.g. a line printer or a network printer) is incomplete. The documentation is for example scattered across archived text files and outdated internal wikis. This often means that administrators must rely on their own knowledge or knowledge of others when configuring or updating printing services.

Methods described herein lead to documentation improvement in this scenario. For example, the autonomous reinforcement agent 106 identifies gaps in the existing printer setup documentation. Agent 106 may particularly identify gaps around control language commands, subsystem routing rules, and spool file handling. Agent 106 may query a knowledge base 118 which references code snippets, historical developer notes, and/or relevant system commands. By generating prompt variants and providing the prompt variants to one or more LLMs 114, the agent produces a new documentation version 116. The new documentation version in this scenario includes step-by-step instructions for configuring a printer device on the AS/400 system. The refined documentation includes the correct CRTDEVPRT command syntax, recommended spool file attributes, network connectivity notes and best practices for subsystem configuration. LLM-as-a-judge 120 compares the newly generated documentation to the older version and scores it higher for clarity, completeness, and technical correctness. The agent receives a positive reward, reinforcing the effectiveness of drawing on the knowledge graph to fill in missing control language command details.

In the example scenario, the final improved documentation explicitly maps out each step needed to integrate the new printer into a computing system. It provides control language commands, object libraries, and spool file settings, as well as notes on user authorization and subsystem routing. The documentation is sufficiently detailed that an administrator or a separate DevOps tool can fully automate the AS/400 printer-configuration process. This means that system administrators can rely on the improved documentation (rather than trial and error or outdated references) to quickly set up or modify printers. By enabling a fully automated approach, the documentation helps to reduce errors, accelerate configuration time, and ensure consistent practices across multiple environments.

In an example, a software application executes on a computing system such as an IBM (trademark) AS/400 system or other legacy computing system. In this example, a new documentation version comprises control language commands configured for creating or modifying a peripheral device description such as a printer device description. The new documentation version also comprises step-by-step instructions specifying spool file and subsystem routing parameters for the printer device. The new documentation version comprises sufficient detail to enable an automated or scripted integration of the printer device in the AS/400 environment.

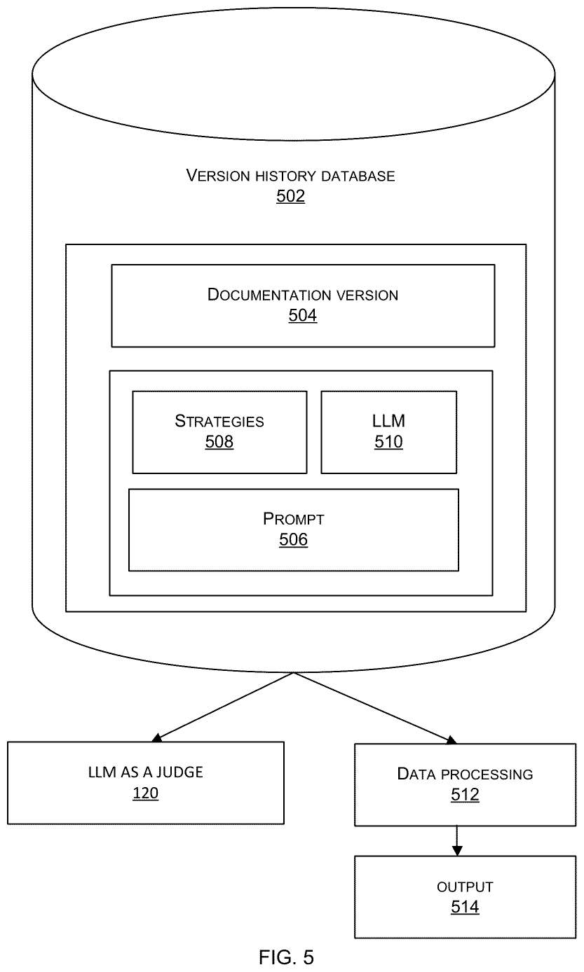

FIG. 5 is a schematic diagram showing a version history database. In various examples described herein version history is generated using documentation versions from each iteration, along with information about the documentation version, also called metadata. 502 is a version history database. Shown in database 502 is an example of a documentation version 504. Also stored in database 502 is information about the documentation version 504 including strategies used to generate the version 508, the LLM used to generate the version 510 and the prompt used to generate the version 506. In version history database 502 there could be stored many documentation versions along with their metadata. In some example scenarios, each new version of the documentation (produced for example by a new prompt, data source integration, or LLM response) is stored along with metadata. The version history database facilitates transparent audits of the improvement process, and enables rollbacks to previous documentation versions if needed. It also reveals patterns consistently enhance quality. Furthermore, it assists in maintaining compliance and verifying that no unauthorized data sources or methods were used.

As depicted schematically in FIG. 5, LLM-as-a-judge 120 may access version history database 502 and use the accessed information to compare documentation versions. Information stored in version history database 502 may be processed as shown at 512. This may reveal patterns in version histories for example identifying strategies or data sources which consistently improve documentation. The information in database 502 may for example be analyzed using machine learning. In various examples, information in database 502 is analyzed 512 by the agent or by an auxiliary analytics component. For example, machine learning is used to analyze information including metadata and version history to identify trends and correlations. Sometimes, clustering is used to group documentation versions that share similar strategies or data sources which may reveal patterns of success. Regression or classification can also be used for data analysis. For example, historical improvement scores generated by LLM-as-a-judge 120 can be used as a target variable in a supervised learning model, which predicts how likely a particular strategy or LLM is to yield an improvement. Another way of analyzing the data is to determine feature importance. Features may be ranked according to how strongly they correlate with improved documentation which may guide future strategies. Example features include presence of code samples or usage of certain data sources. In some examples, output 514 of the data processing may be used by a user to review histories and understand documentation evolution, revert to a previous version or audit how and why certain refinements are made. In some examples, output 514 may be displayed on a graphical user interface.

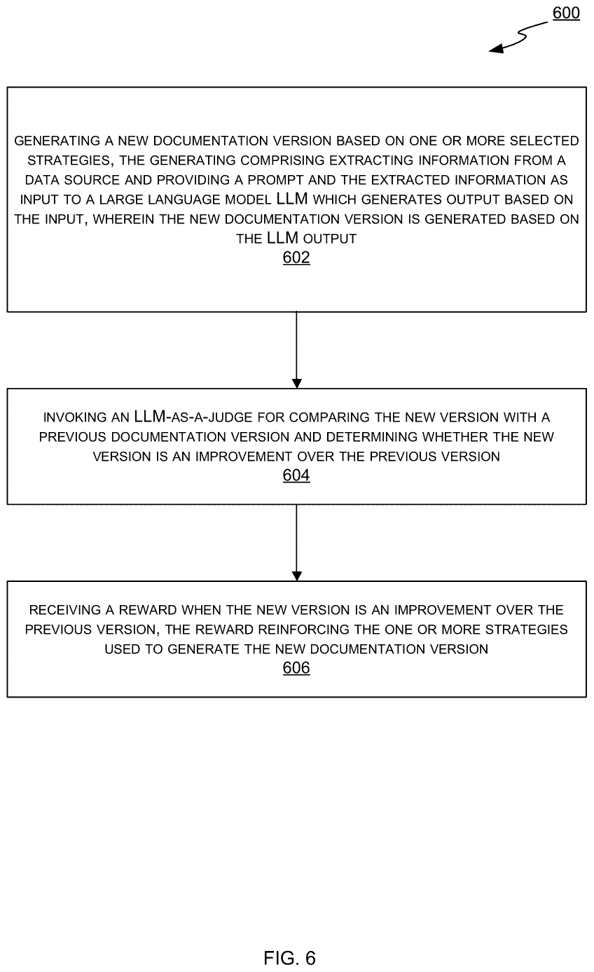

FIG. 6 is a flow diagram showing an example computer-implemented method 600. Method 600 is performed by a computer-implemented artificial intelligence agent. Block 602 shows generating a new documentation version based on one or more selected strategies. As described above the strategies may include one or more of: generating a prompt variant from an initial prompt, generating a plurality of sub-prompts by decomposing an initial prompt; querying a plurality of LLMs, extracting information from a knowledge graph representation of the software application, extracting information from a repository, extracting information from a code archive, extracting information from an internet source, few-shot prompting. The generating comprises extracting information from a data source, for example a knowledge base 118 or an external data source 132. The generating also comprises providing a prompt and the extracted information as input to a large language model LLM. LLMs are depicted for example at 114 in FIG. 1. The LLM generates output based on the input and the new documentation version is generated based on the LLM output.

Block 604 shows invoking an LLM-as-a-judge, for example LLM-as-a-judge 120, for comparing the new version with a previous documentation version. The LLM-as-a-judge determines whether the new version is an improvement over the previous version. This may be based on accuracy, reliability, clarity, style or comprehensiveness.

At block 606 the agent receives a reward when the new version is an improvement over the previous version. This is shown for example at 124 in FIG. 1. The reward reinforcing the one or more strategies used to generate the new documentation version, for example by changing priorities 126 in a prioritised backlog of prompt variants 110.

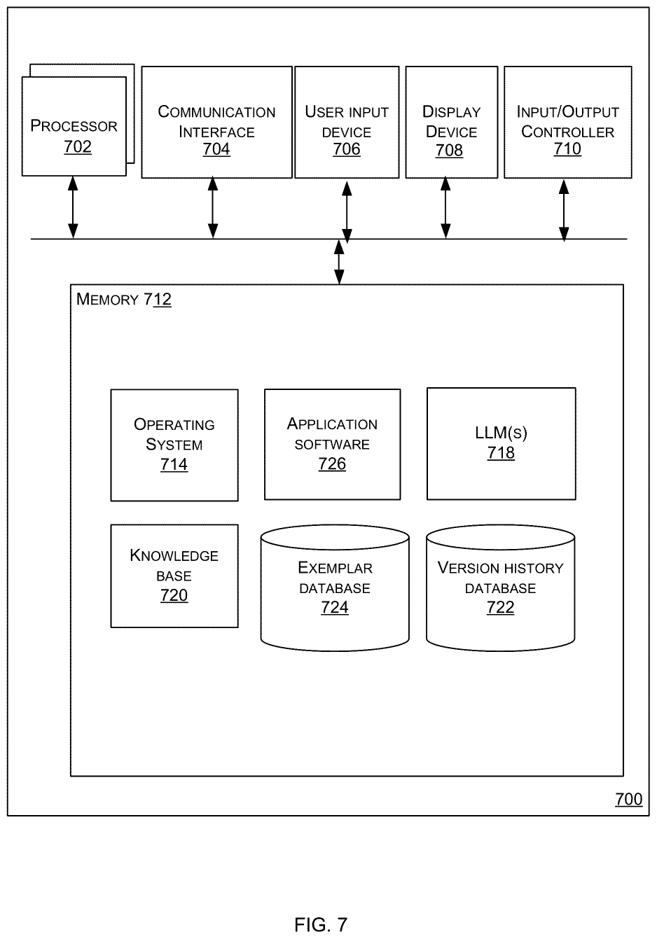

FIG. 7 illustrates various components of an exemplary computing-based device 700 which are implemented as any form of a computing and/or electronic device, and in which any of the methods described above are implemented in some examples.

Computing-based device 700 comprises one or more processors 702 which are microprocessors, controllers or any other suitable type of processors for processing computer executable instructions to control the operation of the device in order to improve documentation. In some examples, for example where a system on a chip architecture is used, the processors 702 include one or more fixed function blocks (also referred to as accelerators) which implement a part of the method of responding to a query about a software application in hardware (rather than software or firmware). Platform software comprising an operating system 714 or any other suitable platform software is provided at the computing-based device to enable application software 726 to be executed on the device. In various examples, software application data 716 is stored in memory 712. In further examples, also stored in memory 712 are one or more large language models 718, a knowledge base 720 such as knowledge base 118 including data about the software application which the documentation relates to, a version history database 722 such as database 502, an exemplar database 724 for generating few-shot prompts which is an example of database 408.

The computer executable instructions are provided using any computer-readable media that is accessible by computing based device 700. Computer-readable media includes, for example, computer storage media such as memory 712 and communications media. Computer storage media, such as memory 712, includes volatile and non-volatile, removable and non-removable media implemented in any method or technology for storage of information such as computer readable instructions, data structures, program modules or the like. Computer storage media includes, but is not limited to, random access memory (RAM), read only memory (ROM), erasable programmable read only memory (EPROM), electronic erasable programmable read only memory (EEPROM), flash memory or other memory technology, compact disc read only memory (CD-ROM), digital versatile disks (DVD) or other optical storage, magnetic cassettes, magnetic tape, magnetic disk storage or other magnetic storage devices, or any other non-transmission medium that is used to store information for access by a computing device. In contrast, communication media embody computer readable instructions, data structures, program modules, or the like in a modulated data signal, such as a carrier wave, or other transport mechanism. As defined herein, computer storage media does not include communication media. Therefore, a computer storage medium should not be interpreted to be a propagating signal per se. Although the computer storage media (memory 712) is shown within the computing-based device 700 it will be appreciated that the storage is, in some examples, distributed or located remotely and accessed via a network or other communication link (e.g. using communication interface 704).

The computing-based device 700 also comprises an input/output controller 710 arranged to output display information to a display device 708 which may be separate from or integral to the computing-based device 700. The display information may provide a graphical user interface. The input/output controller 710 is also arranged to receive and process input from one or more devices, such as a user input device 706 (e.g. a mouse, keyboard, camera, microphone or other sensor). In some examples the user input device 706 detects voice input, user gestures or other user actions. This user input may be used to receive a query at a user interface. In an embodiment the display device 708 also acts as the user input device 706 if it is a touch sensitive display device. The input/output controller 710 outputs data to devices other than the display device in some examples, e.g. a locally connected printing device (not shown in FIG. 7).

Alternatively or in addition to the other examples described herein, examples include any combination of the following:
Clause A. A computer-implemented method performed by an autonomous reinforcement learning artificial intelligence agent for iteratively improving documentation for a software application, the method comprising:
generating a new documentation version based on one or more selected strategies, the generating comprising extracting information from a data source and providing a prompt and the extracted information as input to a large language model LLM which generates output based on the input, the new documentation version being generated based on the LLM output;
invoking an LLM-as-a-judge for comparing the new version with a previous documentation version and determining whether the new version is an improvement over the previous version;
receiving a reward when the new version is an improvement over the previous version, the reward reinforcing the one or more strategies used to generate the new documentation version.
Clause B. The method of clause A, wherein a selected strategy includes prompt variation, and the prompt provided to the LLM is a prompt variant generated from an initial prompt.
Clause C. The method of clause B wherein the prompt variant is generated by providing the initial prompt and an instruction to generate a prompt variant to an LLM.
Clause D. The method of any preceding clause, wherein a selected strategy includes prompt decomposition, and the prompt provided to the LLM is one of a plurality of sub-prompts generated from an initial prompt. Clause E. The method of any preceding clause, wherein a selected strategy includes querying a plurality of LLMs and wherein the new documentation version is generated by combining output from one or more LLMs.
Clause F. The method of any preceding clause, wherein a selected strategy includes one or more of:
extracting information relating to the software application from a knowledge graph representation of the software application;
extracting information relating to the software application from a repository and/or code archive for the software application; or
extracting information relating to the software application from an internet source.
Clause G. The method of any preceding clause, wherein a selected strategy includes few-shot prompting, and wherein the prompt is a few-shot prompt comprising one or more exemplars.
Clause H. The method of clause G, wherein the agent selects the one or more exemplars from an exemplar database of documentation versions.
Clause I. The method of any preceding clause, wherein determining whether the new version is an improvement over the previous version comprises: the LLM-as-a-judge receiving as input the new documentation version, the previous documentation version, and a prompt requesting an indication of whether the new version is an improvement.
Clause J. The method of clause I wherein the prompt provided to the LLM-as-a-judge further comprises a request for comparing one or more of: accuracy, reliability, clarity, style, comprehensiveness.
Clause K. The method of any preceding clause, wherein the autonomous reinforcement learning agent further maintains a priority queue of prompt variations, and wherein the reward reinforcing the one or more strategies used to generate the new documentation version comprises giving higher priority to prompt variants in the queue which are generated using the strategies.
Clause L. The method of any preceding clause, further comprising storing the new documentation version and metadata relating to the new documentation version in a version history database.
Clause M. The method of clause L, wherein the metadata comprises one or more of: a prompt used to generate the new documentation version, a type of LLM used to generate the new documentation version, the one or more selected strategies used to generate the documentation version.
Clause N. The method of any preceding clause wherein the new documentation version includes one or more commands, absent from a previous version of the documentation, for enabling a computing apparatus to perform a computing task using the software application.
Clause O. The method of clause N wherein the commands are control language commands configured for creating or modifying a device description of a peripheral device to be used by the software application.
Clause P. The method of any preceding clause wherein the new documentation version is included in a pipeline configured to perform a computing task and the pipeline is executed such that the computing task is performed.
Clause Q. an Apparatus Comprising:
a processor; and
a memory storing instructions that, when executed by the processor, cause the processor to perform a method comprising:
generating a new documentation version based on one or more selected strategies, the generating comprising extracting information from a data source and providing a prompt and the extracted information as input to a large language model LLM which generates output based on the input, wherein the new documentation version is generated based on the LLM output;
invoking an LLM-as-a-judge for comparing the new version with a previous documentation version and determining whether the new version is an improvement over the previous version;
receiving a reward when the new version is an improvement over the previous version, the reward reinforcing the one or more strategies used to generate the new documentation version.
Clause R. The apparatus of clause Q, wherein the selected strategy includes one or more of: generating a prompt variant from an initial prompt, generating a plurality of sub-prompts by decomposing an initial prompt; querying a plurality of LLMs, extracting information from a knowledge graph representation of the software application, extracting information from a repository, extracting information from a code archive, extracting information from an internet source, few-shot prompting.
Clause S. The apparatus of clause Q or clause R, wherein the method further comprises maintaining a priority queue of prompt variations, and wherein the reward reinforcing the one or more strategies used to generate the new documentation version comprises giving higher priority to prompt variants in the queue which are generated using the strategies.
Clause T. A computer-implemented method performed by an autonomous reinforcement learning agent for iteratively improving documentation for a software application, the method comprising:
generating a plurality of prompt variants, each prompt variant being generated based on a strategy or a plurality of strategies;
for a first prompt in a priority queue of prompt variants, using one or more large language models LLMs to generate a new documentation version by providing the prompt to the LLM and receiving output from the LLM;
comparing the new version with a previous version using an LLM-as-a-judge to determine whether the new version is an improvement;
if the new version is an improvement, receiving a reward;
based on the reward, adjusting the order of prompt variants in the priority queue.

The term ‘computer’ or ‘computing-based device’ is used herein to refer to any device with processing capability such that it executes instructions. Those skilled in the art will realize that such processing capabilities are incorporated into many different devices and therefore the terms ‘computer’ and ‘computing-based device’ each include personal computers (PCs), servers, mobile telephones (including smart phones), tablet computers, set-top boxes, media players, games consoles, personal digital assistants, wearable computers, and many other devices.

The methods described herein are performed, in some examples, by software in machine readable form on a tangible storage medium e.g. in the form of a computer program comprising computer program code means adapted to perform all the operations of one or more of the methods described herein when the program is run on a computer and where the computer program may be embodied on a computer readable medium. The software is suitable for execution on a parallel processor or a serial processor such that the method operations may be carried out in any suitable order, or simultaneously.

Those skilled in the art will realize that storage devices utilized to store program instructions are optionally distributed across a network. For example, a remote computer is able to store an example of the process described as software. A local or terminal computer is able to access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a digital signal processor (DSP), programmable logic array, or the like.

Any range or device value given herein may be extended or altered without losing the effect sought, as will be apparent to the skilled person.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The operations of the methods described herein may be carried out in any suitable order, or simultaneously where appropriate. Additionally, individual blocks may be deleted from any of the methods without departing from the scope of the subject matter described herein. Aspects of any of the examples described above may be combined with aspects of any of the other examples described to form further examples without losing the effect sought.

The term ‘comprising’ is used herein to mean including the method blocks or elements identified, but that such blocks or elements do not comprise an exclusive list and a method or apparatus may contain additional blocks or elements.

Additionally, as used in this disclosure, phrases of the form “at least one of an A, a B, or a C,” “at least one of A, B, and C,” and the like, should be interpreted to select at least one from the group that comprises “A, B, and C.” Unless explicitly stated otherwise in connection with a particular instance in this disclosure, this manner of phrasing does not mean “at least one of A, at least one of B, and at least one of C.” As used in this disclosure, the example “at least one of an A, a B, or a C,” would cover any of the following selections: {A}, {B}, {C}, {A, B}, {A, C}, {B, C}, and {A, B, C}.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the scope of this specification.

What is claimed is:

1. A computer-implemented method performed by an autonomous reinforcement learning artificial intelligence agent for iteratively improving documentation for a software application, the method comprising:
generating a new documentation version based on one or more selected strategies, the generating comprising extracting information from a data source and providing a prompt and the extracted information as input to a large language model LLM which generates output based on the input, the new documentation version being generated based on the LLM output;
invoking an LLM-as-a-judge for comparing the new version with a previous documentation version and determining whether the new version is an improvement over the previous version; and
receiving a reward when the new version is an improvement over the previous version, the reward reinforcing the one or more strategies used to generate the new documentation version.

2. The method of claim 1, wherein a selected strategy includes prompt variation, and the prompt provided to the LLM is a prompt variant generated from an initial prompt.

3. The method of claim 2 wherein the prompt variant is generated by providing the initial prompt and an instruction to generate a prompt variant to an LLM.

4. The method of claim 1, wherein a selected strategy includes prompt decomposition, and the prompt provided to the LLM is one of a plurality of sub-prompts generated from an initial prompt.

5. The method of claim 1, wherein a selected strategy includes querying a plurality of LLMs and wherein the new documentation version is generated by combining output from one or more LLMs.

6. The method of claim 1, wherein a selected strategy includes one or more of:
extracting information relating to the software application from a knowledge graph representation of the software application;
extracting information relating to the software application from a repository and/or code archive for the software application; or
extracting information relating to the software application from an internet source.

7. The method of claim 1, wherein a selected strategy includes few-shot prompting, and wherein the prompt is a few-shot prompt comprising one or more exemplars.

8. The method of claim 7, wherein the agent selects the one or more exemplars from an exemplar database of documentation versions.

9. The method of claim 1, wherein determining whether the new version is an improvement over the previous version comprises: the LLM-as-a-judge receiving as input the new documentation version, the previous documentation version, and a prompt requesting an indication of whether the new version is an improvement.

10. The method of claim 9 wherein the prompt provided to the LLM-as-a-judge further comprises a request for comparing one or more of: accuracy, reliability, clarity, style, comprehensiveness.

11. The method of claim 1, wherein the autonomous reinforcement learning agent further maintains a priority queue of prompt variations, and wherein the reward reinforcing the one or more strategies used to generate the new documentation version comprises giving higher priority to prompt variants in the queue which are generated using the strategies.

12. The method of claim 1, further comprising storing the new documentation version and metadata relating to the new documentation version in a version history database.

13. The method of claim 12, wherein the metadata comprises one or more of: a prompt used to generate the new documentation version, a type of LLM used to generate the new documentation version, the one or more selected strategies used to generate the documentation version.

14. The method of claim 1 wherein the new documentation version includes one or more commands, absent from a previous version of the documentation, for enabling a computing apparatus to perform a computing task using the software application.

15. The method of claim 14 wherein the commands are control language commands configured for creating or modifying a device description of a peripheral device to be used by the software application.

16. The method of claim 1, wherein the new documentation version is included in a pipeline configured to perform a computing task and the pipeline is executed such that the computing task is performed.

17. An apparatus comprising:
a processor; and
a memory storing instructions that, when executed by the processor, cause the processor to perform a method comprising:
generating a new documentation version based on one or more selected strategies, the generating comprising extracting information from a data source and providing a prompt and the extracted information as input to a large language model LLM which generates output based on the input, wherein the new documentation version is generated based on the LLM output;
invoking an LLM-as-a-judge for comparing the new version with a previous documentation version and determining whether the new version is an improvement over the previous version; and
receiving a reward when the new version is an improvement over the previous version, the reward reinforcing the one or more strategies used to generate the new documentation version.

18. The apparatus of claim 17, wherein the selected strategy includes one or more of: generating a prompt variant from an initial prompt, generating a plurality of sub-prompts by decomposing an initial prompt; querying a plurality of LLMs, extracting information from a knowledge graph representation of the software application, extracting information from a repository, extracting information from a code archive, extracting information from an internet source, few-shot prompting.

19. The apparatus of claim 17, wherein the method further comprises maintaining a priority queue of prompt variations, and wherein the reward reinforcing the one or more strategies used to generate the new documentation version comprises giving higher priority to prompt variants in the queue which are generated using the strategies.

20. A computer-implemented method performed by an autonomous reinforcement learning agent for iteratively improving documentation for a software application, the method comprising:
generating a plurality of prompt variants, each prompt variant being generated based on a strategy or a plurality of strategies;
for a first prompt in a priority queue of prompt variants, using one or more large language models LLMs to generate a new documentation version by providing the prompt to the LLM and receiving output from the LLM;
comparing the new version with a previous version using an LLM-as-a-judge to determine whether the new version is an improvement;
if the new version is an improvement, receiving a reward; and
based on the reward, adjusting the order of prompt variants in the priority queue.
